(19) United States
(12) Patent Application Publication
(10) Pub. No.: US 2008/0281693 A1
(43) Pub. Date: Nov. 13, 2008

(54) METHODS OF FINANCING CONSTRUCTION AND SALES OF REAL PROPERTY

(75) Inventor: Kjell Eriksson, Brea, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: AMERICAN RESEARCH AND DEVELOPMENT INSTITUTE INC.

(21) Appl. No.: 11/748,434

(22) Filed: May 14, 2007

Related U.S. Application Data
(60) Provisional application No. 60/916,785, filed on May 8, 2007.

(51) Int. Cl. G06Q 40/00

(52) U.S. Cl. 705/14; 705/35

(57) ABSTRACT

Financial instruments incentivize the development of low income real property by retaining profitability similar to property sold at fair market value. A REEIP is proposed wherein investors profit by receiving units of real property at a substantial discount that may be subsequently sold or rented after title passes to the investor. A construction fees, costs, or tax instrument are built into each real property unit and issued as a second or subsequent mortgage for all fees and compliance costs, which allows the purchaser of the real property to purchase the real property at a discount by removing the fees and compliance costs from the purchase price of the real property. Finally, real property may be sold to qualifying low income purchasers by allowing a developer to gradually turn over equity in a low income home to the purchaser over a predetermined time period, which is secured by a forgivable mortgage.

### RELATED APPLICATIONS

The present disclosure claims the Paris Convention priority of Provisional Application Ser. No. 60/916,785 filed on 8 May 2007 entitled “Improved Methods of Financing Construction and Sales of Real Property,” the contents of which are hereby expressly incorporated by reference as if fully disclosed herein.

### BACKGROUND

This disclosure relates to financial tools designed to reduce the cost of real property, such as houses. Specifically, the methods disclosed herein provide methods for offering/selling homes at below market value prices while retaining a profit margin sufficient to induce developers to build low income housing.

### SUMMARY

Financial instruments incentivize the development of low income real property by retaining profitability similar to property sold at fair market value. A real estate equity investment program (REEIP) is proposed wherein investors profit by receiving units of real properly at a substantial discount that, may be subsequently sold or rented after title passes to the investor. A construction fees, costs, or tax instrument are built into each real property unit and issued as a second or subsequent mortgage, for all fees and compliance costs, which, allows the purchaser of the real property to purchase the real property at a discount by removing the fees and compliance costs from the purchase price of the real property. Finally, real property may be sold to qualifying low income purchasers by allowing a developer to gradually turn over equity in a low income home to the purchaser over a predetermined time period, which is secured by a forgivable mortgage.

According to a feature of the present disclosure, a method is disclosed comprising offering by a first entity to at least a second entity a financial instrument in exchange for capital to develop real property, and providing an option to be exercised by each second entity whereby each second entity may elect to be repaid with at least one second instrument entitling the second entity to a portion of the developed real property. The financial instrument is offered to the second entity at a price reflecting a discounted portion of the fair market value of the developed real property.

According to a feature of the present disclosure, a method is disclosed comprising offering by a first entity to a second entity of a financial instrument to pay at least one fee, cost, or tax imposed by at least one third entity in the purchase of real property. The financial instrument is secured by a second or subsequent mortgage on the real property.

According to a feature of the present disclosure, a method is disclosed comprising discounting the purchase price of a real property offered by a first entity to a second entity, and retaining an equity interest by the first entity that is remitted to the first entity incrementally over a predetermined time period. If the second entity sells the real property prior before the predetermined time period elapses, the first entity retains a percentage of the equity.

According to a feature for the present disclosure, a method is disclosed comprising at least one of the following submethods. The first submethod comprises offering by a first entity to a second entity a first financial instrument in exchange for capital to develop real property, providing an option to be exercised by the second entity whereby the second entity may elect to be repaid with at least one second instrument to the developed real property, and wherein the first financial instrument is offered to the second entity at a price reflecting a discounted portion of the fair market value of the developed real property. The second submethod comprises at least one of the groups of steps further comprising: (1) offering by a third entity to a fourth entity of the developed real property a second financial instrument to pay at least one fee or tax imposed in the purchase of the developed real property; wherein the second financial instrument is secured by a second or subsequent mortgage on the developed real property; and (2) discounting the purchase price of the developed real property offered by a first entity to a fourth entity; and retaining an equity interest by the first entity that is remitted to the seller over a predetermined time period; wherein if the fourth entity sells the developed real property prior before the predetermined time period elapses, the first entity retains a percentage of the sale proceeds. Furthermore, the developed real property may be offered as low income housing.

### Drawings

The above-mentioned features and objects of the present disclosure will become more apparent with reference to the following description taken in conjunction with the accompanying drawings wherein like reference numerals denote like elements and in which:

FIG. 1 is flow diagram of an embodiment of a real estate equity investment program method of the present disclosure;

FIG. 2 is a flow diagram of an embodiment of a method for having a lender recoup government and compliance fees paid for by lender and issued to a purchaser of real property as a second or subsequent mortgage;

FIG. 3 is a flow diagram of an embodiment of a method for removing government and compliance fees for a real property out of a mortgage; and

FIG. 4 is a table of an embodiment of a method for transferring equity to a purchaser of real property.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to he understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims. As used in the present disclosure, the term “or” shall be understood to be defined as a logical disjunction and shall not indicate an exclusive disjunction unless expressly Indicated as such or notated as “xor.”

Over the last decade, the price of housing has risen sharply. The rate of wage increase and economic growth, however, has lagged behind the rate in which the cost of housing has increased leaving behind many families who cannot afford to break into the housing market. Part of the housing crisis stems from recent trends in the buying and selling cycles of housing and availability of mortgages that require no equity payments for a period of time. Notwithstanding, the fundamental problem in the housing industry is a shortage of housing nationwide.

An additional problem with respect to housing are development fees and governmental compliance costs. These costs represent any fee, cost, or tax that is typically paid for in and that an individual or family must qualify for in a mortgage. The housing crisis is particularly pronounced for the low-income segments of the population.

The definition of those who purchase low-income housing today includes families where the wage earners are teachers, police, fire fighters, secretaries and administrative assistants, and so forth. Indeed, in the state of California, many of these public servants and other employees who are crucial to communities find that they can no longer afford to live in the communities in which they work. These low-income individuals are forced to live outside of the communities in which they work and commute each day to work or accept the prospect that they may never own a home of their own.

The demand for housing, and in particular low-income housing, continues to grow. As of Dec. 1, 2004, over 7 million low-income minority families were targeted as needed permanent housing. The same is true among the American Indian nations. The National American Indian Housing Council recently announced they are in need of 230,000 additional homes to be built in American Indian nations over the next 10 years. Extrapolating these numbers into the population generally means that over the next decade the rate in which affordable housing is constructed must Increase to a large degree.

However, developers are profit motivated entities, and will not build low-income housing without government contracts with subsidies attached, which represent tax revenues that would otherwise be allocated in other areas or not collected from the tax base in the first place. The present inventor has discovered financial instruments that not only provide incentives for developers to build low-income housing, but also induce investors to bring private capital in the low-income development projects. Moreover the financial instruments of the present disclosure helps individuals and families afford housing but subsidizing down payments and taking the problem of governmental fees out of the mortgage equation. Notwithstanding the utility of the present methods, the inventor expressly contemplates an extension of the principles and method of the present disclosure to non-low-income situations.

Accordingly, three financial instruments are disclosed herein: an improved real estate equity investment program financial instrument, a financial instrument for removing fees, costs, and tax out of mortgages thereby reducing the amount of money a potential borrower must qualify for in order to purchase real property, and a forgivable gradual equity transfer instrument whereby a purchaser receives an increasing percentage of equity in a real property in exchange for a discount on the real property. The inventor expressly contemplates that these instruments and the underlying methods may be used alone or in various combinations with one other to both incentivize the development of real property and make the real property more affordable generally.

### Real Estate Equity Investment Program (REEIP)

A REEIP is designed to provide an incentive for investors in a development of real property to lend capital to cover the cost of the development. Traditionally, investors invest capital in a development and receive a portion of the developers profits. In the traditional model, however, three problems are prevalent. First, the investor depends on the developer to turn a profit. Moreover, when profits are scarce, equity partners and developers are at odds as to whom gets what percentage of the profits. If the developer fails to turn a profit on a development, the investor does not realize a return on the investment of capital except for interest on the initial loan of capital. Second, the profits for the investor mature as the last units are sold in the development, i.e., at the end of the development project or phase. Third, the investor receives profits in lump sums, which can he quite large. Due to negative tax consequences inherent in receiving large lump sum payments, the investor may be left with a race to reinvest the lump sum payment or accept negative tax consequences. The result of the REEIP of the present disclosure reduces the risk of severely reduced profits for the developer, in addition to the advantages outlined above and the other advantages inherent with REEIPs.

According to an embodiment of the present disclosure, the traditional return to the equity partner is improved by offering to the equity partner an option through a REEIP for discounted units of real property in lieu of cash. The advantage to such a strategy is that the investor is in control of how they recoup cash on their investment because the investor chooses how to dispose of the unit of real property. For example, an investor may receive five houses in a housing development at a discount. The investor may then sell one house a year to space out the cash flowing from the initial investment and avoid the negative tax consequences associated with a large lump sum profits payment. Moreover, the investor and developer may agree to vest the transfer of title for the developed real property during each phase or during the development project generally, thus accelerating the investors return on investment.

Moreover, the investor is in control of the rate of return depending on when the real property units are sold. A savvy investor may wait to sell the real property units until the market is in a favorable seller's market, which increases the value of the real property units and increases the profits earned on the original investment. Indeed, the investor may even retain the developed real property units as rental properties thereby creating a permanent revenue stream.

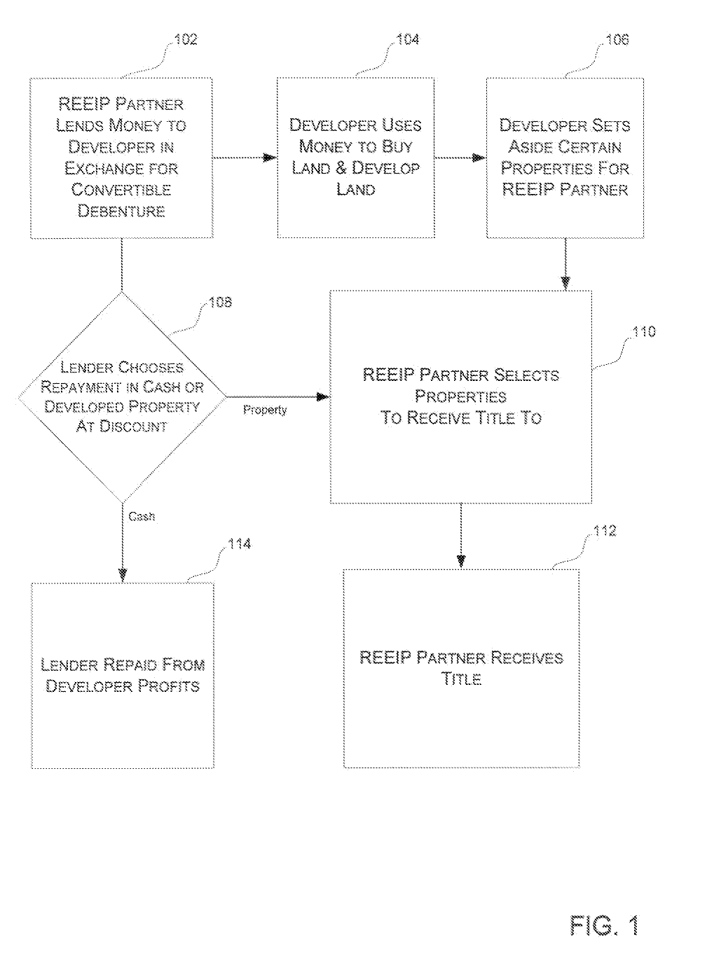

According to an embodiment disclosed herein and illustrated in FIG. 1, there is shown a method of the equity participation or REEIP method. According to the exemplary embodiment illustrated, a REEIP partner lends capital to a developer in operation 102. The capital may be lent in many forms according to embodiments, including cash or land, for example. According operation 102 of the exemplary embodiment, the developer gives the lender a convertible debenture or similar debt instrument having an option, to either receive profits as in the traditional model or receive profits in form of units of the developed real property. The advantage to a convertible debenture, for example, is that it may be freely traded as a security, according to embodiments. According to other embodiments, no such option may be offered—the investor must take profit by way of developed real property units. According to still other embodiments, some equity partners may participate in the REEIP disclosed herein and some may participate in the traditional method in a development; similarly, a single REEIP partner, according to embodiments, may participate both ways in a single development.

After the investor lends that capital to the developer in operation 102, the developer uses the capital for the real property development in operation 104. A real property development may be any development of real property as known to artisans including housing tracts, tracts of empty lots for custom homes, town home developments, condominium developments, office space developments including office buildings, apartment complexes, parking structures, recreational developments, developments dedicated to the arts, malls or strip mall-type developments, campgrounds, retirement communities, recreational vehicle parks, and the other developments of real property. According to embodiments, real property may be divided into developed real property units, such as individual houses, townhouses, condominiums, or apartments; offices, office building floors, office spaces, etc.; parking spaces, parking structure levels, or parking revenue shares; store fronts; etc. Artisans will know and understand the various ways of dividing each developed real property unit that will be appropriate for the present disclosure in addition to those already disclosed. Indeed, each developed real property unit may comprise a developed real property unit or a profit share of a single development entitling the holder to a percentage of profits based on the percentage of total shares held, or similar arrangements. According to embodiments, combinations of different types of developed real property is contemplated. For example, an investor may invest in a mall development. In addition to a number of store front units received, the REEIP partner could also receive a percentage of rights to the ongoing profits on the revenues earned from the shared areas of the mall, such as valet fees, independent vendor cart or display revenues, and so forth.

Turning still to FIG. 1 and according to embodiments, the developer sets aside specific developed real property units from which investors may choose from as the properties to which they will have the option of taking title in operation 106. According to embodiments, the cost of building the REEIP homes is amortized into the non-REEIP homes. Having the developer set aside specific developed real property units prevents the investors from taking all of the best properties for themselves, which will impact the profits of the developer and potentially the fair market value of units throughout the entire development. According to embodiments, the determination of which properties are available to the lender is determined on a case by case basis, and may be a separate point of negotiations between the developer and the lender.

According to embodiments, the investor may choose repayment in the form of cash in operation 114, as in typical arrangements, or may choose to receive developed real property units in operation 108. According to embodiments, the developer offers to the investor an option as part of the convertible debenture wherein the investor receives the title to each developed real property unit at a discount. Thus, the investor recoups on their investment in the form of the difference between the discount of the developed real property units and the fair market value at the time the developed real property unit is sold. As previously disclosed, the investor therefore determines both when they will sell/rent, which allows the investor to dictate how much they will recoup on their investment depending on what is done with each developed real property unit and the related timing of each action.

In operation 110, the investor selects developed real property units to which they will take title. According to embodiments, if they are to receive shares of profits for example, operation 110 will be irrelevant; generally, operation 110 applies when there are distinct, developed real property units to choose from such as houses, condos, townhouses, or office spaces. According to embodiments, if multiple REEIP partners lend capital according to operation 102, then each lender will take turns choosing developed real property units according to some predetermined order.

According to embodiments, a investor receives title to each unit of developed real property in operation 112. The title may be delivered as soon as each developed real property unit that will be passed to the investor is completed, according to embodiments. According to other embodiments, the investor receives title at the end of each development project or at the end of each phase of the development. When the title is transferred at the end of a project or phase, the demand for developed real property units in the development may be matured such that the developed real property units are of increased value when the investor assumes the title. According to still other embodiments, transfer of title to each real property unit may occur at times negotiated by the developer and the investor.

According to embodiments, the investor is permitted to earn rental revenues of completed developed real property units prior to assuming the title to the developed real property unit. For example, the investor having an option for a title to a developed real property unit in a housing tract may elect to have developed real property unit used as a demo model when it is completed. In that case, the developer, who owns the title at the time, pays the investor a rental or use fee. The developer is required to furnish, the demo unit, according to embodiments. The developer, according to the exemplary embodiment, would perform repairs and pay for insurance.

According to embodiments, the developer may restrict transfer of the convertible debenture or debt instrument wherein the investor has a future right to title in developed real property units. Such a restriction avoids allowing the investor to “flip” the developed real property unit prior to its completion and undermine the fair market value of the other units of the development. According to embodiments, the investor may transfer the convertible debenture or debt instrument only to another investor. For example, the other investor must meet the criteria of Rule 506 of Regulation ‘D’ promulgated under the Securities Act of 1933, that is, another entity that can afford to lose their investment. According to other embodiments, the investor may not transfer or sell the developed real property units whatsoever until after they assume the title.

According to embodiments, if the investor goes through bankruptcy and most liquidate assets, the developer has a right of first refusal under terms mutually agreed upon when the convertible debenture or debt instrument was negotiated. Thus, the developer may assume the right, to the title of the developed real property units that the investor would have otherwise been entitled to. Similarly, if the developer chooses not to exercise the right of first refusal, according to embodiments, the person or entity that assumes the right to assume the title to the developed real property units will be under the same set of restrictions on the transfer of the right to the title as was the original lender.

The lender determines the rate of return and gets better control of the tax consequences than if the investor were to take a lump sum payment, as in traditional real property tract deals. Moreover, the leader needs not depend on the developer to torn a profit, nor does the investor generally need to wait until the sale of the last developed real property units in a development project or phase to recoup on the investment.

### Construction Fees, Costs, or Tax Instrument

A construction fees, costs, or tax instrument is a financial instrument that pays for all or some of the fees, costs, and tax associated with the purchase of real property units. The financial instrument is secured using the real property unit, for which the fees are paid as a security interest and is thus applied as a second or subsequent mortgage at a lower interest rate than the primary mortgage on the real property unit.

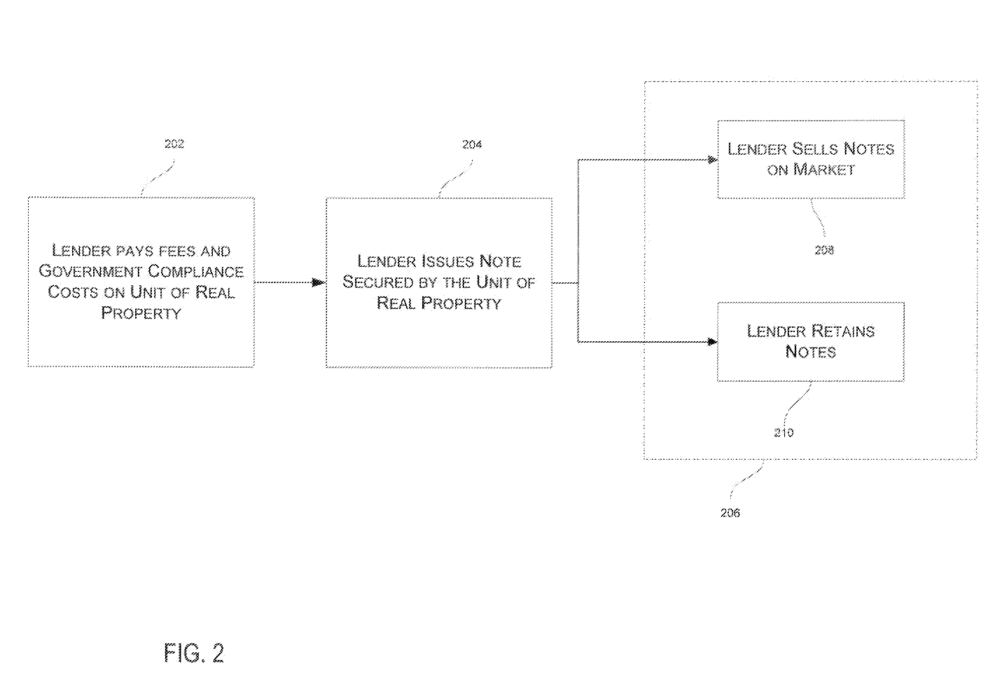

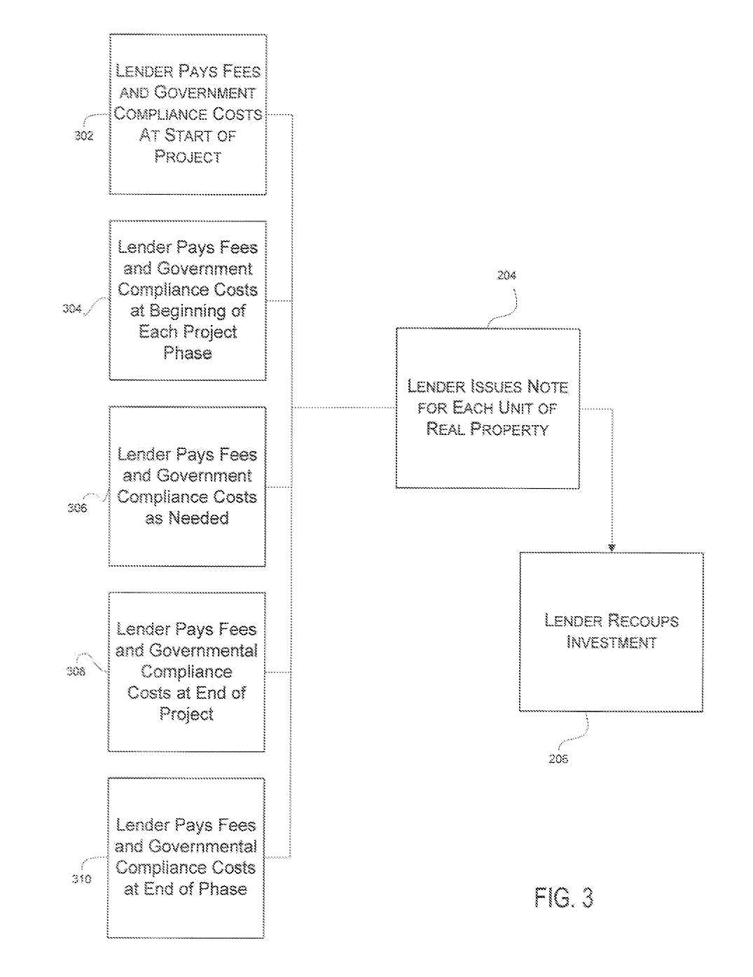

According to an embodiment illustrated in FIG. 2, a lender pays the fees, costs, or taxes for a real property unit in operation 202. According to embodiments, the lender may be the developer of the real property unit. The lender, according to an embodiment illustrated by FIG. 3, pays the fees, costs, or taxes at at least one of a variety of times: before the commencement of and during each development in operation 302, before the commencement of each phase of a development in operation 304, as needed when each fee, cost, or tax is due in operation 306, at the end of a development project in operation 308, or at the end of each development, phase in operation 310. The lender would obtain permission from the city, county, or state for payment at the end of the phase or project as shown in operations 308 and 310. Additionally, according to embodiments, combinations of the various timings presented are possible. For example, payment of certain fees, costs, or taxes my be paid at the start of each phase, while other fees, costs, or taxes may be paid at the end of the phase.

Referring again to FIG. 2, the lender issues a note or other form of debt instrument for the fees paid on each unit of real property in operation 204. According to embodiments, the note is secured by the developed unit of real property, thereby making it a mortgage, as shown in operation 204. Such a mortgage may be considered a second or subsequent mortgage, according to embodiments.

In operation 206, the lender recoups the value of the fees, costs, or taxes paid. The lender may retain the note and be reimbursed over time with interest in operation 210, or the lender may sell the note in a market, such as the bond market, in operation 208. By selling the notes on the bond market, according to embodiments, the lender need only be out of pocket for the fees, costs, or taxes for a short time, for example a day, prior to recoup the investment in operation 206.

The construction fees, costs, or tax instrument is advantageous to buyers because they need not qualify for as large a mortgage. For example, if the total fees, costs, or taxes are $25,000, the purchaser need, qualify for a mortgage for the price of the real property unit less $25,000. Moreover, because the construction fees, costs, or tax instrument may carry a lower interest rate than the first mortgage, according to embodiments, the purchaser pays less for the fees, costs, or taxes over time. In particular, low-income families benefit by retaining more money that may be later converted into consumer spending or the low income family may be able to qualify for a mortgage that they otherwise couldn't afford. Consequently, the purchaser does not need to qualify to pay the fees, costs, or taxes on top of the price of the real property unit.

### Gradual Equity Transfer Instrument

A gradual equity transfer instrument is a financial instrument that helps purchasers, particularly low income purchasers, purchase a home. The gradual equity transfer instrument is particularly effective in housing markets, for example, where the purchaser cannot afford a reasonable down payment. The gradual equity transfer instrument provides an incentive to lenders to provide a discount in the real property unit purchased.

Today, the time a typical American family spends in one house is between 4-6 years. Based on the average time families spend in a single home, the lender issues a forgivable note that is applied as a second or subsequent mortgage on a home. According to embodiments, payments are not made on the note. Rather a percentage of the equity in the real property unit is forgiven according to a predetermined schedule. According to embodiments, the equity owed on the note is determined at the time of the sale as the fair market value of the real property unit when it is purchased.

According to embodiments, a lender to waive the down payment requirement for a home by offering a discount to the purchaser over fair market value in the amount of the down payment. Thus, the purchaser need not make a down payment for the house in exchange for the gradual equity transfer instrument.

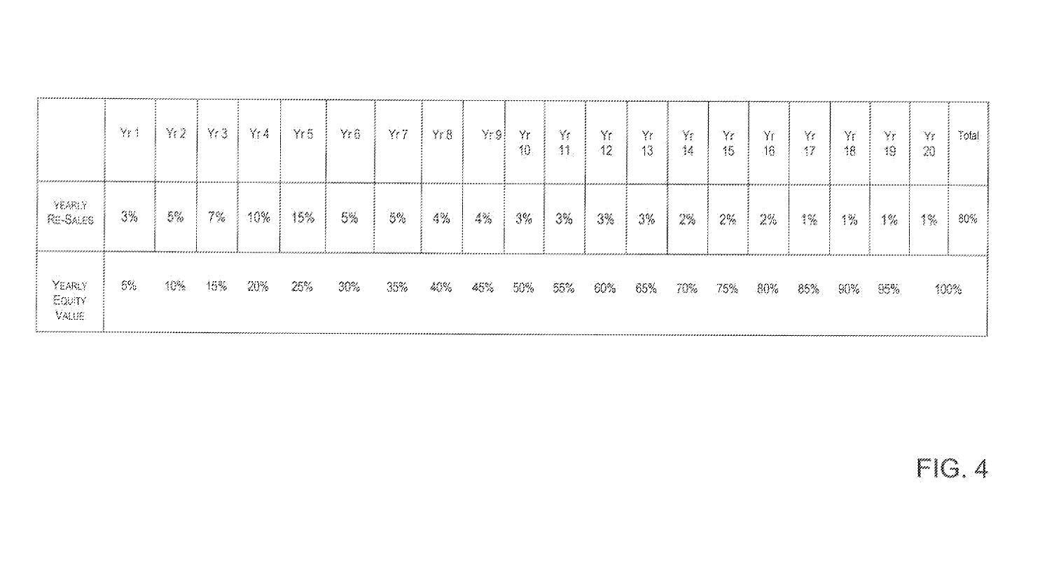

As illustrated in an embodiment of FIG. 4, a gradual equity transfer instrument has a term of 20 years. Each year, 5% of the equity in the real property unit is forgiven. Thus, after one year the purchaser is entitled to 5% of the equity as shown in the Yearly Equity Value row. The Yearly Resales row shows the percentage of buyers who sell during that particular year. Artisans will readily observe that the majority of home owners sell their house within 8 years. Thus, the lender stands to recoup on early sales of the houses with a large return that diminishes over time. The purchaser also benefits because they are able to purchase a home where they would otherwise be unable to afford one; when the purchaser sells, although they are not entitled to all the equity, they do get a portion that can be turned into a down payment in the traditional way. Consequently, the gradual equity transfer instrument incentivizes the lender to help the purchaser buy the real property unit and the purchaser is able to ease into markets that they could otherwise not afford.

Equity, for the purposes of the gradual equity transfer instrument, may be measured in different ways, according to embodiments. In an embodiment, the equity returned to the purchaser is equal to the discount, or the “built-in” equity, the lender gives to the purchaser at the time of purchase that is used in lieu of or as a reduction of a down payment. Thus, whatever additional equity is accrued (“market equity”), such as due to the increase in the value of the real property, belongs to the purchaser alone. According to other embodiments, equity may be measured as the total equity in a home when it is sold, including whatever additional equity, such as that accrued due to the increase in the value of the property. According to still other embodiments, a portion of whatever additional equity is accrued may be considered as equity for the purpose of the gradual equity transfer instrument and the purchaser will he solely entitled to the remainder of whatever additional equity is accrued. Artisans will appreciate that whatever portion of principle of the mortgage paid by the purchaser is equity to which the purchaser is solely entitled.

For example, a house is purchased for $150,000 in 2007. When the purchaser buys the house, the lender gives the purchaser a discount of $15,000, which serves as the purchasers down payment (the “built-in equity”). According to the terms of the note, the equity for the purposes of the gradual equity transfer instrument is the built-in equity. For sake of simplicity, assume the purchaser has paid interest only on the mortgage whereby the amount of principle owed at the time the house is sold is equal to the amount borrowed for the mortgage. Each year, 5% of the built-in equity is forgiven by the lender to the purchaser. When the purchaser sells the home in 2011 for $200,000, the purchaser retains $50,000 of their equity earned from the increase of the house's value (“market equity”). Additionally, the purchaser is entitled to 20% of the built-in equity, or $3,000, which may be reinvested together with the market equity as a down payment for another home. By staying in the home longer, the purchaser recoups more of the built-in equity. Because the purchaser receives a discount on the fair market value of the home, there is little risk that the purchaser will loose money because the house will be sold at fair market value.

If, according to the terms of the note, the equity is defined as the total equity (market equity+built in equity), the developer would also retain a portion of the market equity. For example, according to the note the developer may be entitled to all of the increase in equity of the borne, which is automatically forgiven over time as disclosed herein. Therefore, when the house is sold in 2011 for $200,000, the total equity in the house is $50,000 (market equity)+$3,000 (built-in equity), or $53,000. In this case, the purchaser would be entitled to 20% of the total equity, or $10,600.

Other, hybrid scenarios are also plausible. For example, each year 5% of total equity is forgiven. The basis for the total equity for the purposes of the gradual equity transfer instrument may be calculated, as 100% of the built-in equity and 50% of the market equity. According to the example above, the purchaser would be entitled to 50% of the market equity free and clear. The other 50% of the market equity would be forgiven together with the built-in equity. Thus, the purchaser would be entitled to 20% of the built in equity (20% of $15,000=$3,000), plus 20% of ½ of the market equity of $50,000 (20% of ½ of market, equity of $50,000=$5,000), plus the remaining 50% market equity ($25,000) for a total of $33,000.

According to still other embodiments the financial instruments disclosed herein may be combined. For example, the developer may decide to participate in a low-income housing project wherein the REEIP methods disclosed herein are utilized. To get low-income purchasers into the homes, the developer may sell the real property unit without the fees, costs, and tax that the purchaser would otherwise pay for included in the purchase price by paying for the fees, costs, or taxes via the construction fees, costs, or tax instrument. The developer could then sell the notes for the mortgages on the bond market, recouping the investment without out of pocket long term. Moreover, to aid the low income purchasers, the gradual equity transfer instrument could be utilized to help low-income purchasers get into homes without, coming up with a down payment.

For example, a qualified low-income purchaser would buy a home that costs $400,000 at fair market value. However, because the purchaser is a low-income purchaser, the developer chooses to reduce the profit margin substantially such that the home would otherwise sell for $300,000. By removing the fees, costs, or taxes from the sales price of the home, for example $25,000, the purchaser actually purchases the home for $275,000.

According to the exemplary embodiment, the purchaser then must qualify only for a $275,000 mortgage, with a second mortgage as security interest in the construction fees, costs, and tax instrument. Moreover, the developer discounts the home an additional $13,750 (a 5% “down payment” on $275,000), which represents the down payment the purchaser would otherwise have to come up with/qualify for using the gradual equity transfer instrument, which becomes a third, forgivable mortgage for which no payments are made. Because $13,750 is “built-in” equity, the bank will lend the money for the mortgage without the down payment, because it is built into the home and in a foreclosure sale the bank will sell it for fair market value. Each year, the purchaser gets back 5% of the equity.

Thus, upon a sale after three years, the purchaser is entitled to 15% of the built-in equity per the gradual equity transfer instrument and must repay two mortgages: the mortgage held by the bank for the purchase price of the home and the construction fees, costs, and tax instrument. Assume the house sells for $420,000 after three years. Also assume the purchaser owes at the time of the sale $250,000 on the mortgage and $21,000 on the construction fees, costs, and tax instrument. Thus, at the time of the sale, the “built-in” equity is $13,750 and the market equity is $20,000 (fair market value when house is sold minus fair market value when the house was bought). Thus, the total equity, including the equity earned by virtue of paying off the mortgages is $149,000. Of the $149,000, the purchaser is entitled to $115,250, which represents the amount the purchaser paid against the mortgage. The purchaser is also entitled to the market equity of $20,000. Finally, under the terms of the gradual equity transfer instrument, the purchaser is entitled to 15% of the total equity after three years; the purchaser would retain $2,062.50 of the built-in equity as well and would owe the developer $11,687.50, representing 85% of the built-in equity as the price of moving into the home without paying a cent out of pocket.

According to the example, a person of ordinary skill in the art will recognize that the methods of the present disclosure provide both incentives to developers to build low-income housing, low-income purchasers benefit because more low-income housing is available, the low-income purchaser is enabled to break, into a housing market, that they could otherwise not afford, and the low-income purchaser retains the ability to stay in the market after selling their home.

Moreover, artisans will readily recognize that, the above methods are adaptable for any first-time buyer according to embodiments. Similarly, according to embodiments, the construction fees, costs, and tax instrument may be applied to the sale of any real property. Likewise the REEIP instrument is universally applicable to any development of real property.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
offering by a first entity to at least a second entity a financial instrument in exchange for capital to develop real property;
providing an option to be exercised by each second entity whereby each second entity may elect to be repaid with at least one second instrument entitling the second entity to a portion of the developed real property; and
wherein the financial instrument is offered to the second entity at a price reflecting a discounted portion of the fair market value of the developed real property.

2. The method of claim 1, wherein the second entity may elect to be repaid, on a cash basis.

3. The method of claim 1, further comprising transferring the second instrument for each portion of real property to the second entity after a prescribed time period.

4. The method of claim 1, wherein the second entity may only transfer the financial instrument to an investor.

5. The method of claim 4, wherein the investor is as defined under Rule 506 of Regulation ‘D’ promulgated under the Securities Act of 1933.

6. The method of claim 1, wherein each second entity may use the real property as a demonstration property prior to receiving the at least one second instrument and wherein the first entity pays a fee for use of the demonstration property.

7. The method of claim 1, wherein each second entity may select, from an offering of developed real property provided by the first entity, the developed real property to which each second entity will receive the second instrument.

8. A method comprising:
offering by a first entity to a second entity of a financial instrument to pay at least one fee, cost, or tax imposed by at least one third entity in the purchase of real property;
wherein the financial instrument is secured by a second or subsequent mortgage on the real property.

9. The method of claim 8, wherein, the financial instrument is sold to a fourth entity.

10. The method of claim 9, wherein the fourth entity is at least the bond market.

11. The method of claim 8, wherein the financial instrument serves as a down payment for the real property.

12. The method of claim 8, wherein the financial instrument is automatically issued to each second entity when the real property is purchased.

13. The method of claim 8, wherein each second entity does not qualify for the financial instrument prior to being offered the financial instrument.

14. The method of claim 8, wherein the real property serves as low income housing.

15. A method comprising:
discounting the purchase price of a real property offered by a first entity to a second entity;
retaining an equity interest by the first entity that is remitted to the first entity incrementally over a predetermined time period;
wherein if the second entity sells the real property prior before the predetermined time period elapses, the first entity retains a percentage of the equity.

16. The method of claim 15, wherein the retained equity interest is in the form of a second or subsequent mortgage.

17. The method of claim 16, wherein the second entity makes no payments on the second or subsequent mortgage.

18. The method of claim 15, wherein the first entity forgives percentages of real property incrementally during at least one time point during the predetermined time period.

19. The method of claim 15, wherein the value of the discount serves as a percentage of a second entity's down payment for the real property.

20. The method of claim 15, wherein the real property is offered as low income housing.
